(19) United States
(12) Patent Application Publication
(10) Pub. No.: US 2022/0067632 A1
(43) Pub. Date: Mar. 3, 2022

(54) SCHEDULING OPTIMIZATION

(71) Applicant: Amazon Technologies, Inc., Seattle, WA (US)

(72) Inventors: Amritpal Singh, Glen Allen, VA (US); Sandeepkumar Racherla, Bellevue, WA (US); Rajashekar Maragoud, Seattle, WA (US); Manikandarajan Ramanathan, Redmond, WA (US); Yang-Su Chen, Seattle, WA (US); Ananth Gubbi Suryanarayana, Kirkland, WA (US)

(21) Appl. No.: 17/003,444

(22) Filed: Aug. 26, 2020

(51) Int. Cl. G06Q 10/06; G06N 20/00; G06Q 10/10

(52) U.S. Cl. CPC G06Q 10/063116; G06Q 10/06375; G06Q 10/1093; G06N 20/00

(57) ABSTRACT

Devices and techniques are generally described for scheduling optimization. In some examples, at least one processor may receive labor order data describing a plurality of work shifts and a respective number of candidates requested for each work shift of the plurality of work shifts. In various examples, an optimized set of schedules may be determined by solving an optimization problem based at least in part on the labor order data and a candidate preference signal representing a predicted popularity of proposed schedules for candidate workers. The optimized set of schedules may selected based on the respective number of candidates requested for each work shift and further based on historical candidate preferences. In at least some examples, first code may be generated that is effective to cause the optimized set of schedules to be displayed by a first computing device.

### BACKGROUND

Scheduling work shifts in an environment with dynamically shifting labor requirements can be a daunting task. Fulfillment of labor demands often needs to meet multiple labor, business, and/or regulatory constraints and/or objectives. Additionally, accounting for candidate schedule preferences introduces an additional dimension to work shift scheduling. In some environments, employees and/or prospective employees (candidates) may be asked questions regarding scheduling preferences. Machine learning models may be used to predict candidate-scheduling preferences based on historical candidate preferences and/or based on question-and-answer sessions.

### BRIEF DESCRIPTION OF DRAWINGS

FIG. 1 is a block diagram illustrating receiving labor order data and generating optimized schedules, according to various embodiments of the present disclosure.

FIG. 2 is a table describing various constraints on the optimization problem of FIG. 1, in accordance with various aspects of the present disclosure.

FIG. 3 is a table describing various optimization objectives of the optimization problem of FIG. 1, in accordance with various aspects of the present disclosure.

FIG. 4 is a table describing various candidate preferences that may be used to solve the optimization problem of FIG. 1, in accordance with various aspects of the present disclosure.

FIG. 5 depicts example pseudocode that may be used to generate a schedule according to various aspects of the present disclosure.

FIG. 6 depicts example pseudocode that may be used to implement a sweeper algorithm in accordance with various aspects of the present disclosure.

FIG. 7 depicts another example of labor order data that may be used to generate optimized schedules in accordance with various aspects of the present disclosure.

FIG. 8 depicts an example of an optimized set of schedules that may be generated using the various techniques described herein in response to the labor order data of FIG. 7.

FIG. 9 is a block diagram showing an example architecture of a computing device that may be used in accordance with various embodiments described herein.

FIG. 10 is a diagram illustrating an example system for sending and providing data that may be used in accordance with the present disclosure.

FIG. 11 is a flow chart depicting an example process that can be used to determine an optimized set of schedules, in accordance with various aspects of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Large-scale fulfillment services may operate various distribution, warehouse, and/or sorting centers, which may be critical links in the supply chain. For example, fulfillment services operated by large-scale e-commerce services may include multiple sites within a particular marketplace (e.g., within the United States). In various examples, each of the sites may require from hundreds to thousands of employees to be hired every week in order to meet workload demands. In various examples, the high-volume hiring may be based fulfillment of labor order (LO) data for each of the sites every week. Labor order data may describe labor requirements at each of the sites for a given time period (e.g., per week, per month, etc.). Labor orders may be dynamic as they are the direct outcome of highly dynamic customer and/or business needs reverberating through the fulfillment service. Additionally, fulfillment of LOs may be required to meet multiple business constraints, human resource compliance constraints, regulatory constraints, and/or schedule preferences of candidates (e.g., prospective employees) to improve the likelihood of successful fulfillment of these LOs.

In various embodiments described herein, determining schedules to offer candidates that are optimized for specific LO data is described. In various examples, an optimization problem may be solved by leveraging a Mixed Integer Non-Linear Programming (MINLP) method with maximization of LO fulfillment as an objective and with a constraint space including multiple constraints. In various embodiments, the details of the LO fulfillment objective and its fulfillment constraints are described. Additionally, in some embodiments, the mathematical modeling of the scheduling problem as an MINLP is described. Further, various embodiments describe how the model is further modified to decouple the complexity arising from non-linearity to efficiently solve the optimization problem at scale. The term “candidate,” as used herein, refers to a prospective or current employee that may be employed to work one or more work shifts as part of a fulfillment of a labor order.

Machine learning techniques, such as those described herein, are often used to form predictions, solve problems, recognize objects in image data for classification, etc. For example, herein machine learning techniques may be used to determine candidate schedule preferences based on historical candidate preference data (e.g., machine learning models may be trained to predict candidate preferences based on historical candidate preference data). In various examples, machine learning models may perform better than rule-based systems and may be more adaptable as machine learning models may be improved over time by retraining the models as more and more data becomes available. Accordingly, machine learning techniques are often adaptive to changing conditions. Deep learning algorithms, such as neural networks, are often used to detect patterns in data and/or perform tasks.

Generally, in machine learned models, such as neural networks, parameters control activations in neurons (or nodes) within layers of the machine learned models. The weighted sum of activations of each neuron in a preceding layer may be input to an activation function (e.g., a sigmoid function, a rectified linear units (ReLu) function, etc.). The result determines the activation of a neuron in a subsequent layer. In addition, a bias value can be used to shift the output of the activation function to the left or right on the x-axis and thus may bias a neuron toward activation.

Generally, in machine learning models, such as neural networks, after initialization, annotated training data may be used to generate a cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is often referred to as back propagation.

Generally, in machine learning, an embedding is a mapping of a discrete, categorical variable to a vector of continuous numbers. In neural networks, embeddings are typically of lower dimensions relative to the data that the embeddings represent. In various examples, token embeddings may be generated to represent various text (e.g., review snippets) described herein for input into the various machine learning models described herein.

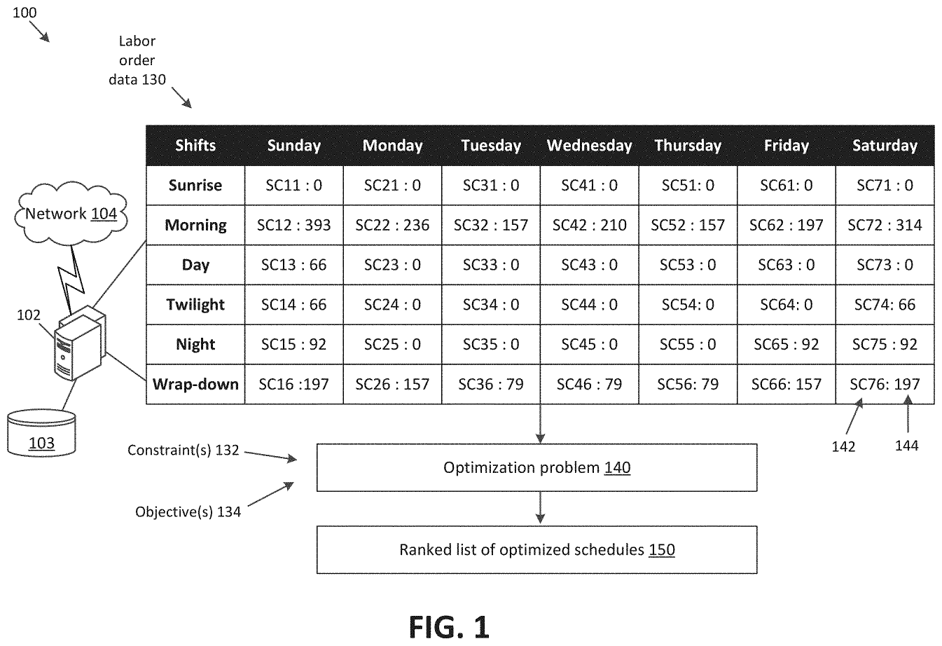

FIG. 1 is a block diagram depicting an example system 100 effective to receive labor order data and generate optimized schedules, according to various embodiments of the present disclosure. In various examples, one or more computing devices 102 may be used to determine a ranked list of optimized schedules 150 based on labor order data 130. Computing devices 102 may communicate with one another and/or with one or more of the other components depicted in FIG. 1 over a network 104 (e.g., a local area network (LAN) and/or a wide area network (WAN) such as the internet). For example, computing devices 102 may communicate with a non-transitory computer-readable memory 103 over network 104. In various examples, the non-transitory computer-readable memory 103 may store instructions that, when executed by at least one processor of the computing devices 102, may cause the computing devices to solve an optimization problem (e.g., optimization problem 140) to determine the ranked list of optimized schedules 150, as described in further detail below.

The objective of optimization problem 140 is to maximize the fulfillment of a given LO, represented by LO data 130. More concretely, the objective is to maximize the fill rate of the demand represented by LO data 130. LO data 130 comprises shift data identifying different work shifts in a given day. As shown in the example LO data 130, there are six different work shifts per day in a given week. However, it should be appreciated that in other implementations there may be a different number of work shifts and the various work shifts may be either partially overlapping or non-overlapping, depending on the implementation. In the example depicted in FIG. 1, each day has the following work shifts: sunrise, morning, day, twilight, night, and wrap-down.

For each work shift on each day, the labor order data 130 may include a work shift code (e.g., shift data) and a requested number of candidates (e.g., candidate data). The work shift code identifies a particular work shift from among other work shifts. For example, work shift code 142 may be data (e.g., the code “SC76”) identifying the Saturday wrap-down work shift from among the other work shifts identified in LO data 130. The number to the right of the colon in the LO data 130 is the requested number of candidates requested to “fill” the particular work shift. For example, for the work shift code 142 (e.g., “SC76”), the requested number of candidates 144 indicates that 197 candidates are requested to work the work shift.

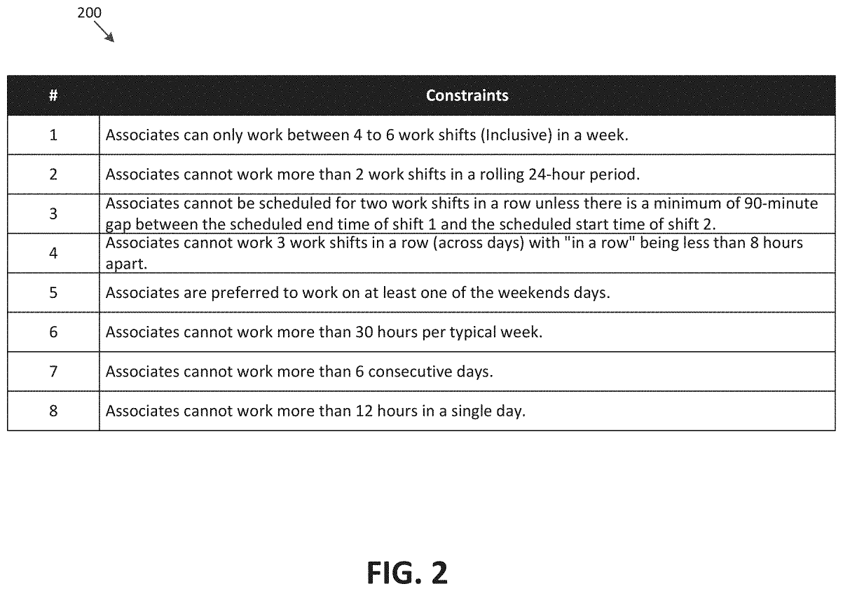

The goal of optimization problem 140 is to offer a list of schedules that maximize the fill rate according to the requested number of candidates for each shift of the LO data 130 and to provide a list of available schedules to candidates via a mobile application such that candidates can select the work shifts that they prefer. Accordingly, ranked list of optimized schedules 150 may be optimized to maximize fulfillment of the labor order data 130 based on both objective(s) 134 and constraint(s) 132. In various examples, the objective(s) 134 may be minimization of one or more of overfills (e.g., more candidates selecting a particular work shift than the requested number of candidates for that work shift) and/or underfills (e.g., fewer candidates selecting a particular work shift than the requested number of candidates for that work shift). In other words, underfills and overfills describe the situation in which the number of candidates selecting a particular work shift/schedule does not match the requested number of candidates for the particular work shift/schedule. Constraint(s) 132 are described in further detail below in reference to FIG. 2.

LO data 130 represents a labor order for a given work site, in a week. LO data 130 represents demand for each of 42 work shifts (e.g., the requested number of candidates for each of the 42 work shifts) which are distributed over a week as a 6-work shift blocks per day. Candidate demand for each of the 42 work shifts in the LO data 130 are not equal. Each work shift and the associated requested number of candidates in LO data 130 represents different underlying demand and can vary widely from site-to-site and from day-to-day and time-to-time. Each cell in the LO data 130 table depicted in FIG. 1 comprises a key-value pair of work shift codes and their corresponding LO demand (e.g., the requested number of candidates for the particular work shift code).

FIG. 2 is a table 200 describing various constraints on the optimization problem of FIG. 1, in accordance with various aspects of the present disclosure. FIG. 2 depicts eight example constraints that may constrain the optimization problem 140 of FIG. 1. In the example constraints depicted in FIG. 2, “associates” are described instead of “candidates.” This is because, once a candidate is hired, the candidate is described herein as an “associate” or “employee.”

A first example constraint in FIG. 2 is that associates may only be permitted to work between four and six work shifts (inclusive) in a given week. Note that the first example constraint is non-linear. In some examples, the minimum number of work shifts and/or the maximum number of work shifts may be different. In at least some examples, the minimum and/or maximum number of permitted work shifts may depend on a classification of the particular associate. For example, part time and/or reduced time associates may be limited to a particular number of work shifts per week that is less than the number of work shifts a full time associate may be permitted to work.

A second example constraint in FIG. 2 is that associates cannot work more than two work shifts in a single 24-hour period. A third example constraint depicted in FIG. 2 is that associates cannot be scheduled for two consecutive work shifts in a row unless there is at least a 90 minute interval between the scheduled end time of the first shift and the scheduled start time of the ensuing second shift. A fourth example constraint in FIG. 2 is that associates cannot work three work shifts in a row that are less than 8 hours apart from one another. A fifth example constraint depicted in FIG. 2 is that associates are preferred to work on at least one of the weekend days.

A sixth example constraint depicted in FIG. 2 is that associates may not be permitted to work for more than 30 hours per typical work week (e.g., unless it is a holiday or if there is an unusual demand for the number of requested candidates). Again, such a limitation on the number of work hours may be related to an associate's status as a part time associate. A seventh example constraint depicted in FIG. 2 is that associates may not be permitted to work more than six consecutive days. In various examples, this constraint may be related to an associate's status and/or to relevant workplace and/or worker regulations and/or worker safety requirements. An eighth example constraint depicted in FIG. 2 is that associates may not be permitted to work for more than 12 hours in a single day (across any number of work shifts). Again, such a constraint may be related to safety regulations and/or other applicable work place regulations.

It should be appreciated that additional and/or fewer constraints apart from what are shown in table 200 may be used in accordance with a given implementation to solve optimization problem 140.

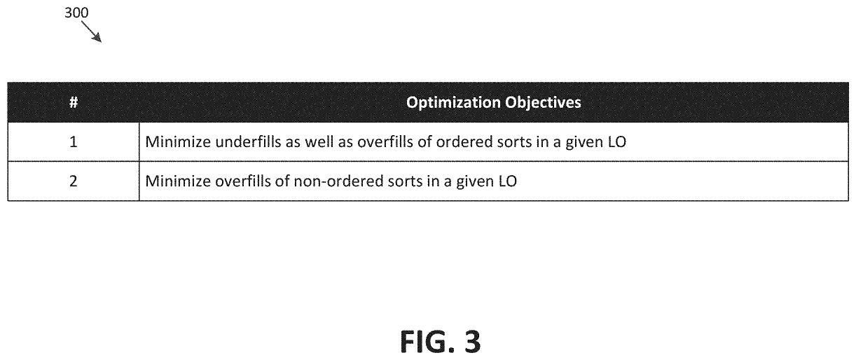

FIG. 3 is a table 300 describing various optimization objectives of the optimization problem of FIG. 1, in accordance with various aspects of the present disclosure. In the example depicted in FIG. 3, table 300 describes two objectives that may be used to solve optimization problem 140 of FIG. 1. The first objective may be to minimize underfills of ordered sorts for given LO data. The second objective may be to minimize overfills of non-ordered sorts in the given LO data (e.g., LO data 130). As used herein, “sorts” refer to work shifts. An ordered sort or work shift is a work shift that is associated with greater than zero requested candidates. A non-ordered sort is a work shift that is associated with no requested candidates. It should be appreciated that additional and/or fewer optimization objectives apart from what are shown in table 300 may be used in accordance with a given implementation to solve optimization problem 140.

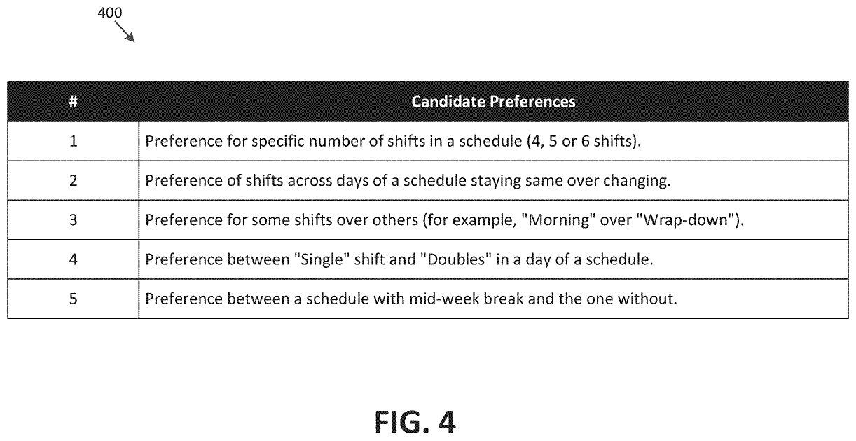

FIG. 4 is a table 400 describing various candidate preferences that may be used to solve the optimization problem 140 of FIG. 1, in accordance with various aspects of the present disclosure. The candidate preferences described in FIG. 4 may be historical data representing past candidate preferences for various work shifts (e.g., of a given LO). The candidate preferences may be for past candidates (e.g., at a given site) and may thus be useful as a signal for predicting future candidate schedule preferences. In various examples, machine learning models such as logistic regression models, decision trees, neural networks, etc., may be used to continuously learn which shifts are selected by candidates. Such machine learning models may be trained using such historical candidate preference data and may be trained to learn to predict candidate preference data for particular schedules and/or work shifts (e.g., based on similarity of a current candidate to past candidates among the historical candidate data). For example, historical data may indicate that candidates with a particular zip code and/or within a particular geographic region may prefer a particular set of schedules and/or work shifts. The various machine learning models trained using historical data may therefore learn to predict that candidates having the zip code (and/or being from the particular region) may prefer the particular schedules and/or work shifts. The predictions by the machine learning model of various candidate preferences may be encoded as a utility vector that may form part of the objective function of the optimization problem. Accordingly, solving the optimization problem factors in candidate preferences in a continuous learning machine learning environment. In such an environment, the machine learning models may receive signals from candidates (e.g., preference data and/or past shift selection) as well as from an entity providing the labor order data to factor in the latest signals when predicted optimal shifts. Accordingly, using the various techniques described herein, schedules may be continuously optimized based on the latest signals/data.

In the example of FIG. 4, a first candidate preference may be a preference for a specific number of work shifts (e.g., four shifts for a given LO, five shifts for a given LO, or six shifts for a given LO). The second candidate preference of FIG. 4 may be a preference for work shifts across certain days of a schedule either staying the same, or changing from day-to-day. The third candidate preference of FIG. 4 may be a preference for some shifts over others (e.g., candidate historical data may indicate that candidates typically prefer morning shifts over late night shifts). The fourth candidate preference of FIG. 4 may be a preference between a “single” shift and “double” shifts within a day of the schedule. The fifth candidate preference of FIG. 4 may be a preference between a schedule with a mid-week break (e.g., no shifts on Wednesday) and a schedule with no mid-week breaks. It should be appreciated that additional and/or fewer candidate preferences apart from what are shown in table 400 may be used in accordance with a given implementation to solve optimization problem 140.

Returning to FIG. 1, the labor demand for 42 work shifts in the LO data 130 may be solved as an optimal set of 4-shift, 5-shift or 6-shift schedules (optimal work schedules given constraint 1 in FIG. 2). The solution to the optimization problem 140 may be one or more schedules that meets all specified constraints (e.g., all the constraints of FIG. 2), as well as the candidate preferences of table 400 (FIG. 4), and the one or more schedules that maximize the likelihood of achieving the objectives depicted in FIG. 3.

Accordingly, the objective of the optimization model can be expressed as,

maximum u^{T}([x_{i∈{1,2, . . . 7},j∈{1,2, . . . 6}}]^{k∈{4,5,6}}={s={xᵢ₌ᵢ_{₁}ⱼ₌ⱼ_{ᵢ},xᵢ₌ᵢ_{₂}ⱼ₌ⱼ_{₂},i₁≠i₂∨j₁≠j₂}∥s|=k})

where s denotes non-repeating k-shift combination schedules, x_{i,j} denotes i^{th} work shift on j^{th} weekday (in the example there are 42 work shifts to choose from), and u^{T} denotes a utility vector of these schedules (with the vector capturing the candidates' preferences over these schedules).

However, an objective of an optimization model cannot be expressed as above. The objective is first transformed into a set of decision variables. Hence, the objective is rewritten as follows:

maximum u^{T}(x_{i∈{1,2 . . . 7},j∈{1,2, . . . 6},s∈{s}_{₁}_{,s}_{₂}_{, . . . s}_{_{S}}_{}})

where x_{i,j,k} is a work shift x_{i,j} in s^{th} schedule, and S is the total number of possible combinations of work shifts (in the current example, S is approximately 6.2 M). In the current example, there are approximately 260 M (6.2 M×7 days×6 shifts per day) decision variables in the objective function.

Constraints

1. As the objective function is expressed in terms of shifts as decision variables, the integrity of each of S schedules has to be ensured. The schedule integrity constraint for S schedules is

Πₓ_{_{i,j}}_{∈}_{ₛ}x_{i,j}=1,∀s∈{s₁,s₂, . . . s_{S}}.

2. The labor demand constraint for 42 work shifts is

Σₛ₌ₛ_{₁}^{s}^{_{S}}x_{i,j,s}≤d_{i,j},∀i∈{1,2, . . . 7},j∈{1,2, . . . 6}.

3. The constraint for maximum of 2 shifts in a rolling 24-hour period is

Σ_{j,x}_{_{i,j}}_{∈}_{ₛ}x_{i,j}≤2,∀i,s∈{s₁,s₂, . . . s_{S}}.

4. The constraint for 90-minutes between back-to-back shifts is

ΔT=|T(j₁)−T(j₂)|≥90 min|i₁=i₂,∀{xᵢ₌ᵢ_{₁}_{,j=j}_{ᵢ},xᵢ₌ᵢ_{₂}_{,j=j}_{₂},i₁≠i₂∨j₁≠j₂}∈s

ΔS=|S(j₁)−S(j₂)|=1|i₁=i₂,∀{xᵢ₌ᵢ_{₁}_{,j=j}_{ᵢ},xᵢ₌ᵢ_{₂}_{,j=j}_{₂},i₁≠i₂∨j₁≠j₂}∈s.

5. Candidate preference of shifts across days of a schedule staying same (rather than changing) and the business constraint of no 3-work shifts across days are interrelated. However, the former constraint is simpler to model, and also meets the later constraint. Accordingly, the constraint for no 3-shift in a row across days is

j₁=j₂,∀{xᵢ₌ᵢ_{₁}_{,j=j}_{ᵢ},xᵢ₌ᵢ_{₂}_{,j=j}_{₂},i₁≠i₂∨j₁≠j₂}.

6. The constraint for a preference for associates working on one of the weekend days is

x_{1,j}∈s+x_{7,j}∈s≥1,∀s∈{s₁,s₂, . . . s_{S}}.

7. Candidate preference for number of shifts can be addressed by having an optimal work shift mix for each site, but only if the prior distribution of candidates' preferences as well as the likelihood of these candidates applying at the given site is known. As predicting the likelihood of candidates applying at a given site is a separate problem, the prior distribution may be taken from the historical data of corresponding sites, as a starting point. The prior distribution may be used to model the constraint to address candidate preferences. The constraint for candidate preference for number of shifts is (where {N₄, Nₛ, N₆} represents shift mix),

{s={xᵢ₌ᵢ_{₁}_{,j=j}_{ᵢ},xᵢ₌ᵢ_{₂}_{,j=j}_{₂},i₁≠i₂∨j₁≠j₂}∥s|=4}≤N₄

{s={xᵢ₌ᵢ_{₁}_{,j=j}_{ᵢ},xᵢ₌ᵢ_{₂}_{,j=j}_{₂},i₁≠i₂∨j₁≠j₂}∥s|=5}≤N₅

{s={xᵢ₌ᵢ_{₁}_{,j=j}_{ᵢ},xᵢ₌ᵢ_{₂}_{,j=j}_{₂},i₁≠i₂∨j₁≠j₂}∥s|=6}≤N₆.

8. Lower bound for the schedules is

{xᵢ₌ᵢ_{₁}_{,j=j}_{ᵢ},xᵢ₌ᵢ_{₂}_{,j=j}_{₂},i₁≠i₂∨j₁≠j₂}∈s≥0

9. Integrality constraint for the decision variables (as the number of shifts can only be integers) is

x_{i,j,s}∈Zⁿ,∀i,j,s.

10. The rest of the constraints described in FIG. 2 are redundant as they are already covered by one or more of the above-modeled constraints. The rest of the candidates' preferences are captured in the utility vector that is part of the objective function. The details of how the utility vector is constructed is described in further detail below. With the objective function and constraints described above, a Mixed Integer Non-Linear Programming (MINLP) optimization problem is described with a complex non-linear and high-dimensional search space.

Modified MINLP

In order to reduce the complexity arising from non-linearity and high-dimensionality of the search space, search space is built outside of the optimization model so that non-linearity can be decoupled and high-dimensionality can be reduced.

Search Space Construction

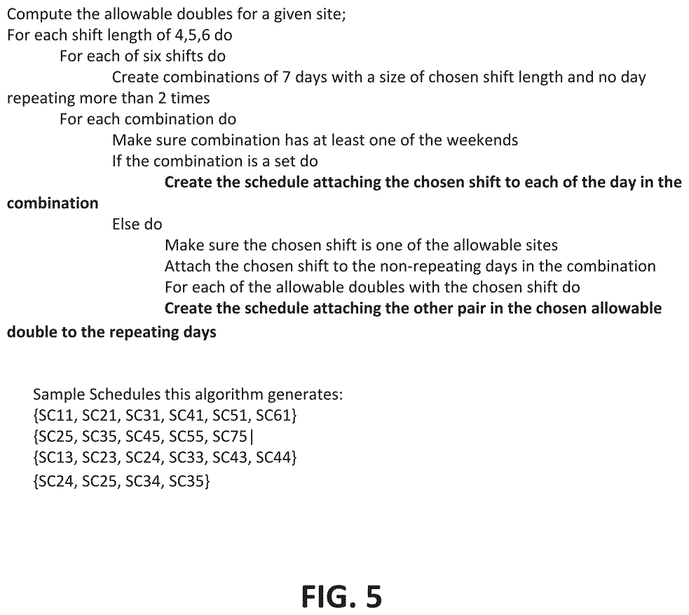

The constraints 1, 3, 4, 5 and 6, above (which are neither too complex to specify nor non-linear in nature) may be used to construct a new search space using the algorithm described below. The search space may be dynamically constructed for each site, as constraint 4 (above) may be different for each site. This technique reduces the size of set of decision variables from 260 M to approximately 15K. FIG. 5 depicts example pseudocode that may be used to construct the search space and generate schedules according to various aspects of the present disclosure.

MILP with Gradually Pruned Search

As non-linearity is decoupled from the search space, the model may be transformed from MINLP with high-dimensional search space to mixed integer linear programming (MILP) with low-dimensional search space. The MILP model is further enhanced with “symmetry-breaking” constraint as combinatorial search may explode for large LOs despite model simplification. This constraint guides the solver to search more efficiently by gradually pruning the search space.

The GLPK (GNU linear programming kit) solver solves this enhanced MILP model in two steps. It first solves the model for linear optimality relaxing the integrality constraint. Second, using the solution in the first step as an upper bound, the GLPK solver solves the model including the integrality constraint using long-step dual simplex method.

maximum u^{T}(x_{i′,s′i′∈{1,2 . . . |s′|},s′∈{s}_{₁}_{,s}_{₂}_{, . . . s}_{_{S′}}_{}})

Subject to Σ_{s′}^{s}^{_{S′}}Σ_{i′=k}x_{i′,s′}≤dₖ,∀k∈{1,2, . . . 42}

Σ_{s″∈{s″⊆s′∥s″|=4}}x_{i′,s″}≤N₄

Σ_{s″∈{s″⊆s′∥s″|=5}}x_{i′,s″}≤N₅

Σ_{s″∈{s″⊆s′∥s″|=6}}x_{i′,s″}≤N₆

{x_{i′=i}_{₁},x_{i′=i}_{₂},i₁≠i₂}∈s′≥0

x_{i′,s′}∈Zⁿ,∀i′,s′

{x_{i′=i}_{₁},x_{i′=i}_{₂},i₁≠i₂}∈s′≤M, as a symmetry-breaking constraint.

Utility Vector Generation

As previously described, the utility vector in the objective function is designed to capture the candidate preferences in order to maximize the likelihood of fulfillment of LO. The candidate preferences are determined using historical data of candidate-selected schedules using machine learning-based techniques. For example, an association rule-mining equivalence class clustering and bottom-up lattice traversal (“ECLAT”) technique may be used to determine the support for frequently co-occurring schedules. The support value may be used as a utility value for the schedules in the constructed search space s′.

The objective function in MILP is formulated such that it captures the candidates' preference for schedules in order to maximize the likelihood of fulfillment of labor order data. The objective function does this by weighting the schedules in the constructed search space s′. The weights are learned continually by a neural network (NN) based machine learning (ML) model for each work site. The weights are continually updated and fed into the objective function as the utility vector described herein. This continual ML-based learning approach improves the solution and maximizes the likelihood of labor order fulfillment.

An example neural network architecture for candidate preference learning is now described. The input layer may comprise features used by the ML model to learn the weights for the objective function of the optimization problem. Examples features may include candidate pick-up propensities (e.g., propensity scores and/or candidate preference scores). The input features used may include such attributes as site identifier, market type, labor order size, schedule length, dominant shift of schedule, single/double shifts, schedules with/without mid-week break, etc. Features such as site identifier, market type, schedule length and dominant shift of schedule may be transformed using one-hot encoding before being fed into the neural network. Labor order size and other such features may be converted into deciles and the deciles may be further transformed using one-hot encoding. The neural network may output a candidate preference signal representing predicted preferences of work shifts that may be integrated into the optimization problem as a utility vector (as described herein).

In various examples, the neural network for determining candidate preferences may include two hidden layers (although any number of hidden layers may be used in accordance with the desired implementation). The hidden layers may be designed to learn not only the linear relationship between the input features and the candidate pickup propensity of a given schedule, but also the non-linear relationship of the features and their interactions with the pickup propensity. In an example implementation, the first hidden layer may include 12 “ReLu” activated neurons, while the second layer may include 12 “Sigmoid” activated neurons. The number of hidden layers and number of neurons in each layer may be selected using hyperparameter tuning in a cross validation step. Different numbers of neurons may be used in each layer, depending on the particular use case and the desired implementation details.

Given a requested labor order LO of a certain size, such as 7 days×6 shifts per day, there are millions of possible work schedules that would need to be investigated by an optimization engine to see if they meet business constraints such as minimum 4 shifts required for a work schedule, not more than two shifts in a day, etc., as well as worker criteria such as shift length, number of shifts per week, etc. The number of possible schedule solutions makes the problem too difficult to solve within an amount of time that is useful during day-to-day business operations. To reduce the problem size and make the problem faster to solve, the search space that the optimization engine explores is reduced from 6.2 M possible schedule combinations to 2.8K combinations by constructing the search space explicitly using an algorithm outside of the optimization framework. In addition, possible schedule solutions are also tested to see how desirable or likeable they might be to employees. In one embodiment, this is done with a location-specific machine learning model that is trained using information from past schedule solutions to identify how desirable a schedule is (e.g., 0 being not desirable at all, 1 being the most desirable). The reduced set of possible schedules is run through the trained ML model (e.g., the neural network described above) to identify those possible schedule solutions that have a threshold desirability. The result from the ML model that determines candidate preferences is applied to an optimization engine that selects a schedule that both meets the business objectives and is likely to be accepted by a candidate.

In an example, data representing the 2.8K combinations of schedules may be input into the trained ML model. The ML model may, in turn, attach propensity/desirability scores to each of the 2.8K schedules. Then, the propensity scores (e.g., the candidate preference signal output by the neural network) of these 2.8K schedules may be passed into the objective function of the optimization engine as the utility vector described herein. The optimization engine maximizes the objective function. In other words, the optimization engine selects the best possible set of schedules with highest desirability/propensity scores while meeting the constraints described herein. The search space is constructed by generating all the possible 6.2 M schedules and by keeping only a subset of the schedules that meets all constraints using the various algorithms described herein.

Neighborhood Search on Shift-Mix Optimization

The solution from the MILP model may sometimes include underfills, though optimal. To minimize the underfills, a linear programming (LP) relaxation technique may be applied. For example, the shift-mix constraints may be relaxed as shown below. Neighborhood search may be carried out to find the next closest shift-mix that yields the minimum number of underfills within the relaxed boundary.

N₄−ε≤Σ_{s″∈{s″⊆s′∥s″|=4}}x_{i′,s″}≤N₄+ε

N₅−ε≤Σ_{s″∈{s″⊆s′∥s″|=5}}x_{i′,s″}≤N₅+ε

N₆−ε≤Σ_{s″∈{s″⊆s′∥s″|=6}}x_{i′,s″}≤N₆+ε

Sweeper Algorithm

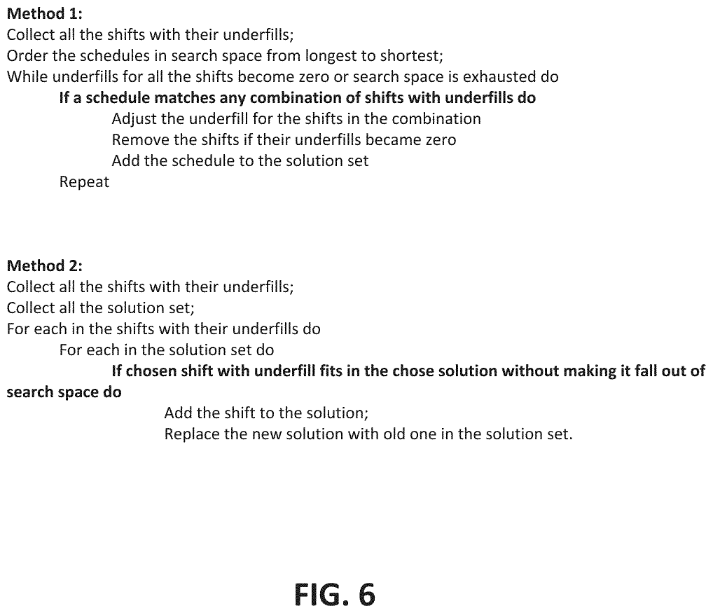

The previously described neighborhood search may not provide a theoretical guarantee for zero underfills, as the relaxation applied is conservative in order to avoid the expensive exhaustive search. The sweeper algorithm may be used as an efficient alternative. The sweeper algorithm iteratively attempts to fill the underfills using two different methods built into the algorithm. FIG. 6 depicts example pseudocode that may be used to implement a sweeper algorithm in accordance with various aspects of the present disclosure.

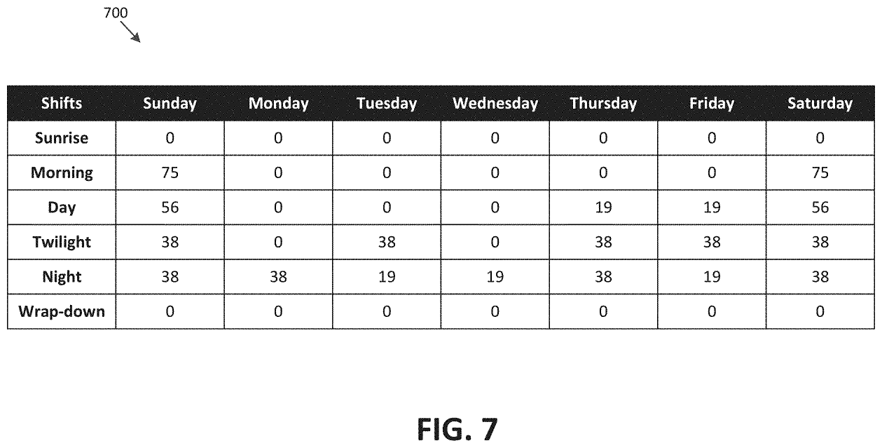

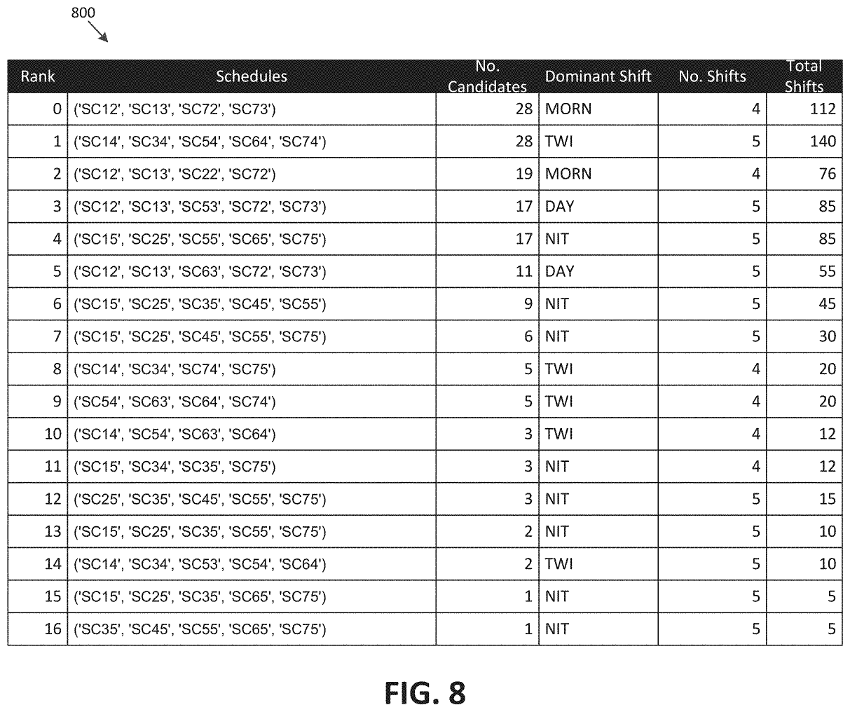

FIG. 7 depicts another example of labor order data 700 that may be used to generate optimized schedules in accordance with various aspects of the present disclosure. FIG. 8 depicts an example of an optimized set of schedules 800 that may be generated using the various techniques described herein in response to the labor order data of FIG. 7. As shown, the various schedules in the set of schedules 800 may be ranked in an order to optimize the fill rates of each work shift of the labor order data 700.

In various examples, code may be generated to cause the sets of optimized schedules in the set of schedules 800 to be displayed on a mobile application. Candidates may use the mobile application to select a schedule. After selection of a schedule by a candidate in the mobile application, the number of requested candidates for that schedule may be decremented. The mobile application may be effective to assign the selected to schedule to the candidate. In other words, after receiving a selection of a first schedule of the ranked list of schedules from a particular candidate (e.g., via the mobile application), the number of candidates requested for the particular schedule may be reduced by one.

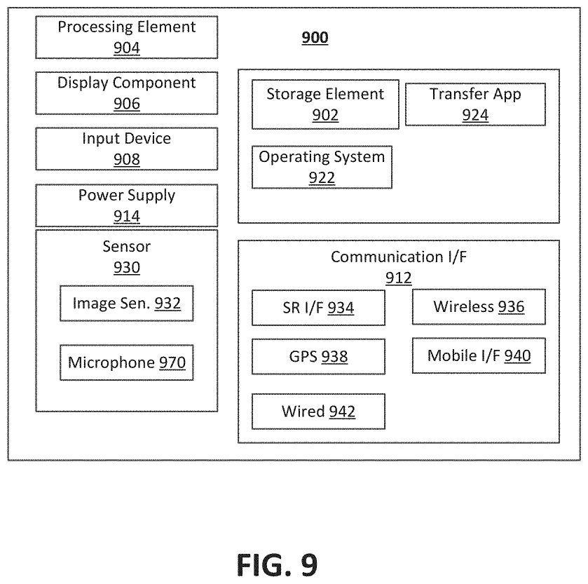

FIG. 9 is a block diagram showing an example architecture 900 of a computing device that may be used to determine optimized schedules and/or execute a mobile application used to select optimized schedules, in accordance with various aspects of the present disclosure. It will be appreciated that not all devices will include all of the components of the architecture 900 and some user devices may include additional components not shown in the architecture 900. The architecture 900 may include one or more processing elements 904 for executing instructions and retrieving data stored in a storage element 902. The processing element 904 may comprise at least one processor. Any suitable processor or processors may be used. For example, the processing element 904 may comprise one or more digital signal processors (DSPs). The storage element 902 can include one or more different types of memory, data storage, or computer-readable storage media devoted to different purposes within the architecture 900. For example, the storage element 902 may comprise flash memory, random-access memory, disk-based storage, etc. Different portions of the storage element 902, for example, may be used for program instructions for execution by the processing element 904, storage of images or other digital works, and/or a removable storage for transferring data to other devices, etc. Additionally, storage element 902 may store parameters, and/or machine learning models used for the various techniques described herein.

The storage element 902 may also store software for execution by the processing element 904. An operating system 922 may provide the user with an interface for operating the computing device and may facilitate communications and commands between applications executing on the architecture 900 and various hardware thereof. A transfer application 924 may be configured to receive images, audio, and/or video from another device (e.g., a mobile device, image capture device, and/or display device) or from an image sensor 932 and/or microphone 970 included in the architecture 900.

When implemented in some user devices, the architecture 900 may also comprise a display component 906. The display component 906 may comprise one or more light-emitting diodes (LEDs) or other suitable display lamps. Also, in some examples, the display component 906 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 906 may be effective to display the various fields and/or GUIs described herein.

The architecture 900 may also include one or more input devices 908 operable to receive inputs from a user. The input devices 908 can include, for example, a push button, touch pad, touch screen, wheel, joystick, keyboard, mouse, trackball, keypad, light gun, game controller, or any other such device or element whereby a user can provide inputs to the architecture 900. These input devices 908 may be incorporated into the architecture 900 or operably coupled to the architecture 900 via wired or wireless interface. In some examples, architecture 900 may include a microphone 970 or an array of microphones for capturing sounds, such as voice requests. In various examples, audio captured by microphone 970 may be streamed to external computing devices via communication interface 912.

When the display component 906 includes a touch-sensitive display, the input devices 908 can include a touch sensor that operates in conjunction with the display component 906 to permit users to interact with the image displayed by the display component 906 using touch inputs (e.g., with a finger or stylus). The architecture 900 may also include a power supply 914, such as a wired alternating current (AC) converter, a rechargeable battery operable to be recharged through conventional plug-in approaches, or through other approaches such as capacitive or inductive charging.

The communication interface 912 may comprise one or more wired or wireless components operable to communicate with one or more other computing devices. For example, the communication interface 912 may comprise a wireless communication module 936 configured to communicate on a network, such as the network 104, according to any suitable wireless protocol, such as IEEE 802.11 or another suitable wireless local area network (WLAN) protocol. A short range interface 934 may be configured to communicate using one or more short range wireless protocols such as, for example, near field communications (NFC), Bluetooth, Bluetooth LE, etc. A mobile interface 940 may be configured to communicate utilizing a cellular or other mobile protocol. A Global Positioning System (GPS) interface 938 may be in communication with one or more earth-orbiting satellites or other suitable position-determining systems to identify a position of the architecture 900. A wired communication module 942 may be configured to communicate according to the USB protocol or any other suitable protocol.

The architecture 900 may also include one or more sensors 930 such as, for example, one or more position sensors, image sensors, and/or motion sensors. An image sensor 932 is shown in FIG. 9. Some examples of the architecture 900 may include multiple image sensors 932. For example, a panoramic camera system may comprise multiple image sensors 932 resulting in multiple images and/or video frames that may be stitched and may be blended to form a seamless panoramic output. An example of an image sensor 932 may be a camera configured to capture color information, image geometry information, and/or ambient light information.

As noted above, multiple devices may be employed in a single system. In such a multi-device system, each of the devices may include different components for performing different aspects of the system's processing. The multiple devices may include overlapping components. The components of the computing devices, as described herein, are exemplary, and may be located as a stand-alone device or may be included, in whole or in part, as a component of a larger device or system.

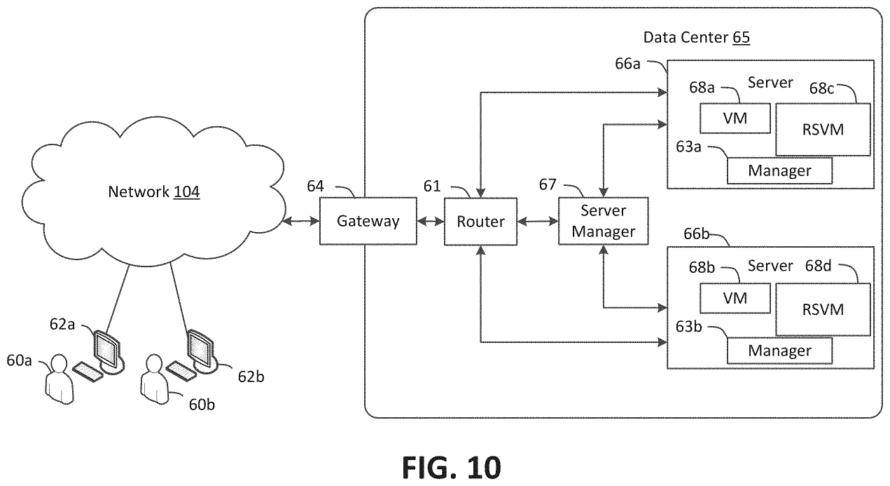

An example system for sending and providing data will now be described in detail. In particular, FIG. 10 illustrates an example computing environment in which the embodiments described herein may be implemented. For example, the computing environment of FIG. 6 may be used to provide the various optimization techniques described herein as a service over a network wherein one or more of the techniques described herein may be requested by a first computing device and may be performed by a different computing device configured in communication with the first computing device over a network. FIG. 10 is a diagram schematically illustrating an example of a data center 65 that can provide computing resources to users 60a and 60b (which may be referred herein singularly as user 60 or in the plural as users 60) via user computers 62a and 62b (which may be referred herein singularly as user computer 62 or in the plural as user computers 62) via network 104. Data center 65 may be configured to provide computing resources for executing applications on a permanent or an as-needed basis. The computing resources provided by data center 65 may include various types of resources, such as gateway resources, load balancing resources, routing resources, networking resources, computing resources, volatile and non-volatile memory resources, content delivery resources, data processing resources, data storage resources, data communication resources and the like. Each type of computing resource may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services, and the like. In various examples, the instances may be configured to execute one or more of the various machine learning techniques described herein.

These services may be configurable with set or custom applications and may be configurable in size, execution, cost, latency, type, duration, accessibility, and in any other dimension. These web services may be configured as available infrastructure for one or more clients and can include one or more applications configured as a system or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Customers may choose to allocate a number of small processing resources as web servers and/or one large processing resource as a database server, for example.

Data center 65 may include servers 66a and 66b (which may be referred herein singularly as server 66 or in the plural as servers 66) that provide computing resources. These resources may be available as bare metal resources or as virtual machine instances 68a-d (which may be referred herein singularly as virtual machine instance 68 or in the plural as virtual machine instances 68). In at least some examples, server manager 67 may control operation of and/or maintain servers 66. Virtual machine instances 68c and 68d are rendition switching virtual machine (“RSVM”) instances. The RSVM virtual machine instances 68c and 68d may be configured to perform all, or any portion, of the techniques for improved rendition switching and/or any other of the disclosed techniques in accordance with the present disclosure and described in detail above. As should be appreciated, while the particular example illustrated in FIG. 10 includes one RSVM virtual machine in each server, this is merely an example. A server may include more than one RSVM virtual machine or may not include any RSVM virtual machines.

The availability of virtualization technologies for computing hardware has afforded benefits for providing large-scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that span multiple distinct physical computing systems.

Referring to FIG. 10, network 104 may, for example, be a publicly accessible network of linked networks and possibly operated by various distinct parties, such as the Internet. In other embodiments, network 104 may be a private network, such as a corporate or university network that is wholly or partially inaccessible to non-privileged users. In still other embodiments, network 104 may include one or more private networks with access to and/or from the Internet.

Network 104 may provide access to user computers 62. User computers 62 may be computers utilized by users 60 or other customers of data center 65. For instance, user computer 62a or 62b may be a server, a desktop or laptop personal computer, a tablet computer, a wireless telephone, a personal digital assistant (PDA), an e-book reader, a game console, a set-top box, or any other computing device capable of accessing data center 65. User computer 62a or 62b may connect directly to the Internet (e.g., via a cable modem or a Digital Subscriber Line (DSL)). Although only two user computers 62a and 62b are depicted, it should be appreciated that there may be multiple user computers.

User computers 62 may also be utilized to configure aspects of the computing resources provided by data center 65. In this regard, data center 65 might provide a gateway or web interface through which aspects of its operation may be configured through the use of a web browser application program executing on user computer 62. Alternately, a stand-alone application program executing on user computer 62 might access an application programming interface (API) exposed by data center 65 for performing the configuration operations. Other mechanisms for configuring the operation of various web services available at data center 65 might also be utilized.

Servers 66 shown in FIG. 10 may be servers configured appropriately for providing the computing resources described above and may provide computing resources for executing one or more web services and/or applications. In one embodiment, the computing resources may be virtual machine instances 68. In the example of virtual machine instances, each of the servers 66 may be configured to execute an instance manager 63a or 63b (which may be referred herein singularly as instance manager 63 or in the plural as instance managers 63) capable of executing the virtual machine instances 68. The instance managers 63 may be a virtual machine monitor (VMM) or another type of program configured to enable the execution of virtual machine instances 68 on server 66, for example. As discussed above, each of the virtual machine instances 68 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 65 shown in FIG. 10, a router 61 may be utilized to interconnect the servers 66a and 66b. Router 61 may also be connected to gateway 64, which is connected to network 104. Router 61 may be connected to one or more load balancers, and alone or in combination may manage communications within networks in data center 65, for example, by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example data center 65 shown in FIG. 10, a data center 65 is also employed, at least in part, to direct various communications to, from, and/or between servers 66a and 66b. While FIG. 10 depicts router 61 positioned between gateway 64 and data center 65, this is merely an exemplary configuration. In some cases, for example, data center 65 may be positioned between gateway 64 and router 61. Data center 65 may, in some cases, examine portions of incoming communications from user computers 62 to determine one or more appropriate servers 66 to receive and/or process the incoming communications. Data center 65 may determine appropriate servers to receive and/or process the incoming communications based on factors such as an identity, location, or other attributes associated with user computers 62, a nature of a task with which the communications are associated, a priority of a task with which the communications are associated, a duration of a task with which the communications are associated, a size and/or estimated resource usage of a task with which the communications are associated and many other factors. Data center 65 may, for example, collect or otherwise have access to state information and other information associated with various tasks in order to, for example, assist in managing communications and other operations associated with such tasks.

It should be appreciated that the network topology illustrated in FIG. 10 has been greatly simplified and that many more networks and networking devices may be utilized to interconnect the various computing systems disclosed herein. These network topologies and devices should be apparent to those skilled in the art.

It should also be appreciated that data center 65 described in FIG. 10 is merely illustrative and that other implementations might be utilized. It should also be appreciated that a server, gateway or other computing device may comprise any combination of hardware or software that can interact and perform the described types of functionality, including without limitation: desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities.

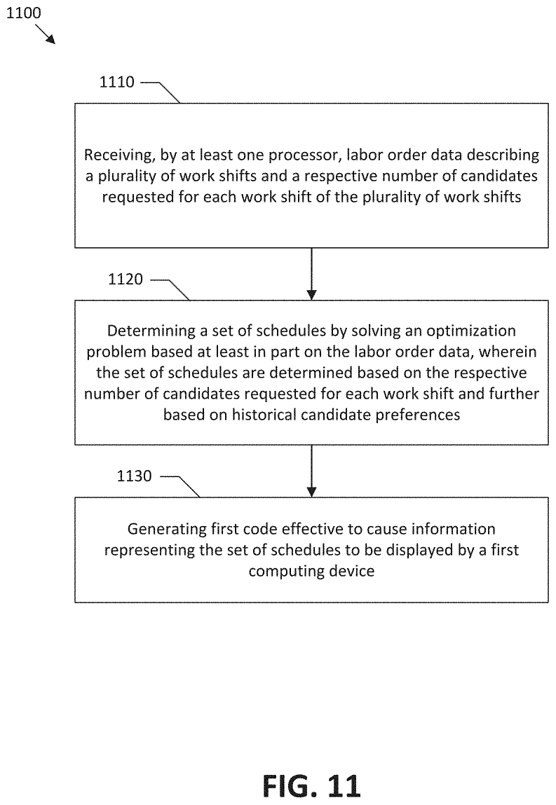

FIG. 11 is a flow chart depicting an example process 1100 that can be used to determine an optimized set of schedules, in accordance with various aspects of the present disclosure. Those actions in FIG. 11 that have been previously described in reference to FIGS. 1-10 may not be described again herein for purposes of clarity and brevity. The actions of the process depicted in the flow diagram of FIG. 11 may represent a series of instructions comprising computer-readable machine code executable by one or more processing units of one or more computing devices. In various examples, the computer-readable machine codes may be comprised of instructions selected from a native instruction set of and/or an operating system (or systems) of the one or more computing devices. Although the figures and discussion illustrate certain operational steps of the system in a particular order, the steps described may be performed in a different order (as well as certain steps removed or added) without departing from the intent of the disclosure.

Process 1100 of FIG. 11 may begin at action 1110, at which at least one processor may receive labor order data (e.g., labor order data 130) describing a plurality of work shifts and a respective number of candidates requested for each work shift of the plurality of work shifts.

Processing may continue to action 1120, at which a set of schedules may be determined by solving an optimization problem using the labor order data. The set of schedules may be determined based on the respective number of candidates requested for each work shift and further based on historical candidate preferences. The historical candidate preferences and/or prediction of current candidate preferences may be determined using a machine learning model that may predict candidate preferences for a current candidate based on historical candidate data.

Processing may continue to action 1130, at which first code may be generated that, when executed, may cause a first computing device to display information representing the set of schedules on a display. In various examples, candidates may select schedules from the displayed set of schedules and may thereby be assigned a particular schedule (e.g., a set of work shifts).

Although various systems described herein may be embodied in software or code executed by general-purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and consequently, are not described in detail herein.

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

1. (canceled)

2. (canceled)

3. (canceled)

4. A method comprising:
receiving, by at least one processor, labor order data describing a plurality of work shifts and a respective number of candidates requested for each work shift of the plurality of work shifts;
determining a set of proposed schedules by solving an optimization problem that takes as input the labor order data, constraint data related to worker regulations, and a candidate preference signal representing a predicted preference of work shifts; and
generating code effective to display the set of proposed schedules on a display of a first computing device.

5. The method of claim 4, further comprising solving the optimization problem based on historical data indicating historical candidate preferences.

6. The method of claim 4, further comprising:
predicting, using a machine learning model, candidate preferences based on historical candidate preferences; and
generating vector data representing the predicted candidate preferences, wherein solving the optimization problem comprises maximizing an objective function that includes the vector data as the candidate preference signal.

7. The method of claim 4, further comprising:
solving the optimization problem using a non-linear constraint, the non-linear constraint limiting a number of work shifts permitted for a given candidate during a given week.

8. The method of claim 4, wherein a first objective of the optimization problem is minimization of underfills of work shifts, wherein an underfill of a first work shift occurs when a number of candidates selecting the first work shift is less than a requested number of candidates for the first work shift.

9. The method of claim 8, wherein a second objective of the optimization problem is minimization of overfills of work shifts, wherein an overfill of a second work shift occurs when a number of candidates selecting the second work shift is less than a requested number of candidates for the second work shift.

10. The method of claim 4, further comprising:
receiving a selection of a first schedule by a first candidate; and
reducing a number of candidates requested for the first schedule by one.

11. The method of claim 4, further comprising solving the optimization problem using a constraint specifying that there be at least a 90 minute interval between two consecutive work shifts.

12. The method of claim 4, further comprising further comprising solving the optimization problem using a constraint specifying that schedules do not include more than two consecutive work shifts.

13. The method of claim 4, further comprising:
generating candidate preference data using a first machine learning model trained using historical candidate preference data; and
generating a utility vector for an objective function of the optimization problem that comprises the candidate preference data.

14. A system comprising:
at least one processor; and
at least one non-transitory computer-readable memory storing instructions that, when executed by the at least one processor, are effective to:
identify labor order data describing a plurality of work shifts and a respective number of candidates requested for each work shift of the plurality of work shifts;
determine a set of proposed schedules by solving an optimization problem that takes as input labor order data, constraint data related to work regulations, and a candidate preference signal representing a predicted preference of work shifts; and
generate code effective to display the set of proposed schedules on a display of a first computing device.

15. The system of claim 14, the at least one non-transitory computer-readable memory storing further instructions that, when executed by the at least one processor, are further effective to solve the optimization problem based on historical data indicating historical candidate preferences.

16. The system of claim 14, the at least one non-transitory computer-readable memory storing further instructions that, when executed by the at least one processor, are further effective to solve the optimization problem using a non-linear constraint, the non-linear constraint limiting a number of work shifts permitted for a given candidate during a given week.

17. The system of claim 14, wherein a first objective of the optimization problem is minimization of underfills of work shifts, wherein an underfill of a first work shift occurs when a number of candidates selecting the first work shift is less than a requested number of candidates for the first work shift.

18. The system of claim 17, wherein a second objective of the optimization problem is minimization of overfills of work shifts, wherein an overfill of a second work shift occurs when a number of candidates selecting the second work shift is less than a requested number of candidates for the second work shift.

19. The system of claim 14, the at least one non-transitory computer-readable memory storing further instructions that, when executed by the at least one processor, are further effective to:
receive a selection of a first schedule by a first candidate; and
reduce a number of candidates requested for the first schedule by one.

20. The system of claim 14, the at least one non-transitory computer-readable memory storing further instructions that, when executed by the at least one processor, are further effective to solve the optimization problem using a constraint specifying that there be at least a 90 minute interval between two consecutive work shifts.

21. A computer-implemented method comprising:
receiving, by at least one processor, labor order data describing a plurality of work shifts and a respective number of candidates requested;
predicting, using a machine learning model, candidate preference data based on historical candidate preferences;
reducing a search space of the machine learning model using mixed integer linear programming;
determining a set of proposed schedules by solving an optimization problem for the search space that takes as input the labor order data, constraint data, and the candidate preference data representing a predicted preference of work shifts; and
generating code effective to display the set of proposed schedules on a display of a first computing device.

22. The computer-implemented method of claim 21, further comprising solving the optimization problem based on historical data indicating historical candidate preferences.

23. The computer-implemented method of claim 21, further comprising:
generating vector data representing the predicted candidate preferences, wherein solving the optimization problem comprises maximizing an objective function that includes the vector data as the candidate preference signal.
